(19) United States
(12) Patent Application Publication
(10) Pub. No.: US 2025/0356397 A1
(43) Pub. Date: Nov. 20, 2025

(54) System and Methods for Marketing Fireworks

(71) Applicant: Elite Fireworks, Houston, TX (US)

(72) Inventor: Valmir Nazifi, Houston, TX (US)

(73) Assignee: Elite Fireworks, Houston, TX (US)

(21) Appl. No.: 19/098,554

(22) Filed: Apr. 2, 2025

Related U.S. Application Data
(60) Provisional application No. 63/648,424, filed on May 16, 2024.

(51) Int. Cl. G06Q 30/0241; G06K 7/10; G06K 19/07

(52) U.S. Cl. CPC G06Q 30/0277; G06K 7/10297; G06K 19/0723

(57) ABSTRACT

A computer-implemented method including scanning a radio tag incorporated into packaging of a firework product to retrieve a tag data record, the tag data record comprising a source identifier, a firework product identifier, and a universal resource identifier (URI); and at least one of: adding a product data record to a product database, the product data record comprising at least the firework product identifier, and requesting from the URI content related to the firework product.

### RELATED PATENT APPLICATION

This application claims priority to commonly owned U.S. Provisional Patent Application No. 63/648,424, filed on May 16, 2024, which is hereby incorporated by reference.

### FIELD OF THE INVENTION

The present application relates to systems and methods for recording information about consumer fireworks employing NFC communications.

### BACKGROUND

The fireworks industry follows the same distribution and information practices as it has for decades, if not centuries, with minimal information provided on packaging and rare advancement in packaging technology. Sales channels break bulk and distribute product but provide no additional information to intermediate or end customers. The fireworks industry currently has no digital tagging, dynamic packaging, or programmable content delivery mechanisms. In today's market, fireworks packaging is entirely static. Product information is permanently fixed at the time of manufacture and typically limited to printed branding, barcodes, and general safety instructions. Once packaged, there is no way to tailor or update the information presented to the consumer based on where the product is sold, how it is promoted, or who the end user is. This lack of flexibility is a significant disadvantage in a highly regulated, regionally varied, and campaign-driven environment where content should ideally adapt based on geography, distributor, retail location, or promotional timeline. The inability to change or localize product-linked digital experiences post-manufacture creates operational friction, compliance risk, and missed marketing opportunities.

Near Field Communication (NFC) technology has emerged as a versatile tool for enabling short-range wireless communication between devices. This technology allows for the exchange of small amounts of data between an NFC tag and a reader device. NFC tags are often passive devices that can be embedded in or attached to physical objects, creating a bridge between the physical and digital worlds. In recent years, NFC technology has found applications across various industries, including retail, logistics, and consumer goods. These applications often involve using NFC tags to provide consumers with product information, authentication, or access to digital content. However, NFC technology has not yet been incorporated into the fireworks industry as it has in other industries. Care must be taken when altering practices as changes could alter the risk profile of a hazardous and volatile product. For example, introducing electronic components into fireworks must be done with care to guard against inadvertent or malicious generation of heat or spark that could risk ignition and possible explosion. This is especially critical as more fireworks are combined with electronic ignition systems.

### SUMMARY

Examples of the proposed software system introduce an integrated, field-programmable, cryptographically secure, and offline-resilient NFC content control framework. The framework may allow post-manufacture customization of digital content, tailored to region, retail, or campaign logic, while maintaining full traceability, access control, and compliance readiness. This architecture is an industry-first for the fireworks sector and sets a precedent for dynamic packaging infrastructure across regulated and consumer-facing industries.

Examples of the present disclosure include a non-transitory computer readable medium comprising instructions that when executed on a methodor scan a radio tag incorporated into fireworks packaging to retrieve a unique identifier, transmit the unique identifier to a server, receive a universal resource identifier (URI) from the server, and issue a command to the radio tag to store the URI in a memory of the radio tag.

Examples of the present disclosure include a computer implemented method comprising scanning a radio tag incorporated into fireworks packaging to retrieve a unique identifier, transmitting the unique identifier to a server, receiving a universal resource identifier (URI) from the server, and issuing a command to the radio tag to store the URI in a memory of the radio tag.

Examples of the present disclosure include a computer-implemented method comprising scanning a radio tag incorporated into packaging of a firework product to retrieve a tag data record, the tag data record comprising a source identifier, a firework product identifier, and a universal resource identifier (URI); and at least one of: adding a product data record to a product database, the product data record comprising at least the firework product identifier, and requesting from the URI content related to the firework product by. In some examples, the computer-implemented method comprises signaling the radio tag to overwrite the URI of the tag data record with a replacement URI; and signaling the radio tag to prevent future changes to the tag data record. In some examples, the URI points to first information about the firework product hosted by a first website; and the replacement URI points to second information about the firework product hosted by a second website. In some examples, the second website is sponsored by a fireworks seller. In some examples, the computer-implemented method comprises creating a record in an online database specific to the firework product, the firework product specific record comprising: a scan timestamp, a user identifier, at least one of a reference to a firework distributor and a reference to a firework retailer, and a redirect-URI to provide in response to a request to the replacement URI. In some examples, the computer-implemented method comprises scanning a second radio tag incorporated into the packaging of a composite firework product comprising the firework product to retrieve a composite tag data record, the composite tag data record comprising: a second source identifier associated with the source of the composite firework product, a composite firework product identifier, and a second URI; and adding the composite tag data record to the product database, the composite tag data record comprising at least the composite firework product identifier. In some examples, the computer-implemented method comprises determining the second radio tag is associated with the composite firework product.

Examples of the present disclosure include a non-transitory computer readable medium comprising instructions that when executed on a methodor scan a radio tag incorporated into packaging of a firework product to retrieve a tag data record, the tag data record comprising: a source identifier, a firework product identifier, and a universal resource identifier (URI); and, at least one of, add a product data record to a product database, the product data record comprising at least the firework product identifier, and request from the URI content related to the firework product by. In some examples, the non-transitory computer readable medium comprises instructions that when executed on a methodor signal the radio tag to overwrite the URI of the tag data record with a replacement URI; and signal the radio tag to prevent future changes to the tag data record. In some examples, the URI points to first information about the firework product hosted by a first website; and the replacement URI points to second information about the firework product hosted by a second website. In some examples, the second website is sponsored by a fireworks seller. non-transitory computer readable medium comprising instructions that when executed on a methodor create a record in an online database specific to the firework product, the firework product specific record comprising: a scan timestamp, a user identifier, at least one of a reference to a firework distributor and a reference to a firework retailer, and a redirect-URI to provide in response to a request to the replacement URI. non-transitory computer readable medium comprising instructions that when executed on a methodor scan a second radio tag incorporated into the packaging of a composite firework product comprising the firework product to retrieve a composite tag data record, the composite tag data record comprising a second source identifier associated with the source of the composite firework product, a composite firework product identifier, and a second URI; and add the composite tag data record to the product database, the composite tag data record comprising at least the composite firework product identifier. non-transitory computer readable medium comprising instructions that when executed on a methodor determine the second radio tag is associated with the composite firework product.

Examples of the present disclosure include a device comprising a fuse, a combustible material, a package substantially containing the combustible material, and a radio tag affixed to the package, wherein the radio tag stores a tag data record comprising: a source identifier, a product identifier, and a universal resource identifier (URI). In some examples, the URI was first fixed prior to delivery of the device by the device manufacturer. In some examples, the URI was modified after delivery of the device by the device manufacturer. In some examples, the modified URI points to information about the device hosted by a retail seller. In some examples, the device comprises a second layer of packaging comprising the package and a composite radio tag affixed to the second layer of packaging, the composite radio tag comprising a composite tag data record, the composite tag data record comprising a second source identifier associated with the source of the composite product, a composite product identifier, and a second URI. In some examples, the composite tag data record indicates that the composite radio tag is a composite radio tag.

### BRIEF DESCRIPTION OF THE DRAWINGS

FIGS. 1a and 1b illustrate a system for marketing fireworks, according to certain examples.

FIG. 2 is an illustration of data structures for tracking firework information, according to certain examples.

FIG. 3 is an illustration of a data structures for tracking firework information, according to certain examples.

FIG. 4 is an illustration of a system for tracking firework information, according to certain examples.

FIG. 5 illustrates a method for processing firework information, according to certain examples.

FIG. 6 illustrates a method for managing firework information, according to certain examples.

### DETAILED DESCRIPTION

To address these unmet technical needs, the present disclosure introduces a programmable, software-defined NFC tagging system that allows product-linked content to be dynamically updated even after the product has left the manufacturing facility. This system transforms fireworks packaging from a static object into a real-time digital access point, managed through a secure, cloud-orchestrated infrastructure. This disclosure embeds the tag within a controlled ecosystem that allows for contextual, post-production customization, governed by metadata, user roles, and security logic.

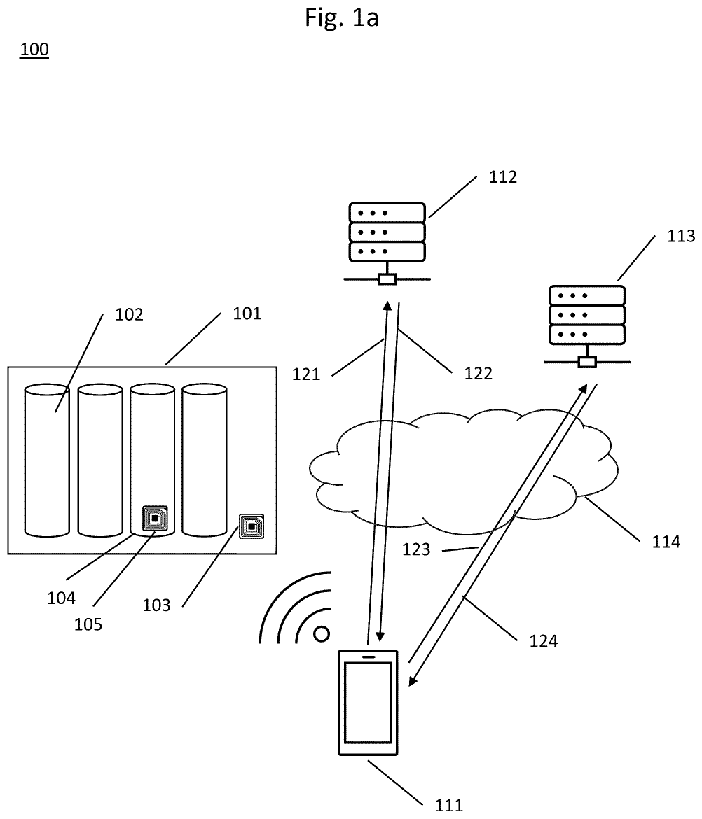

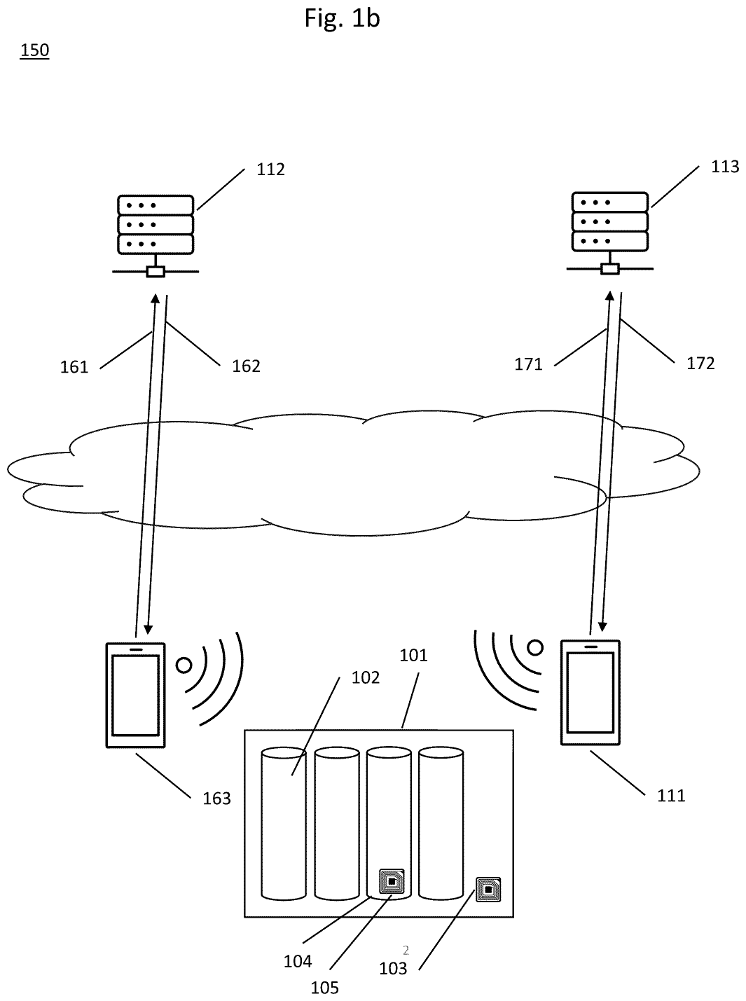

As illustrated in FIGS. 1a and 1b, each fireworks item 101 may include one or more embedded NFC tags (103, 105), that may be initialized during packaging with a unique identifier (UID) and may include a default or placeholder URI. These tags may then be registered with a remote Tag Management Server (TMS) 112, which stores the UID and links it to associated metadata such as a stock keeping unit (SKU) number, batch number, origin point, distributor ID, sales channel, and a uniform resource identifier for a material safety data sheet (MSDS) or a safety data sheet (SDS). The TMS may act as the central logic engine—resolving tag interactions into appropriate URI destinations based on context.

FIG. 1a is an illustration of system 100 for marketing fireworks, according to certain examples. System 100 includes firework package 101. In some examples, firework package 101 may be a composite package that includes multiple individual firework modules 102 and 104 and radio tag devices 103 and 105. In some examples, firework package 101 may include radio tag device 103 at or near a specified location, which may be aligned with a visual packaging indicator of the device location. In some examples, firework module 104 may include radio tag device 105. In some examples, a radio tag device may be a radio frequency identifier (RFID) tag containing a data record. In some examples, a radio tag device may be near field communication (NFC) tag containing a data record. In some examples, the tag's data record may be read only. In some examples, the tag's data record may include a writable portion.

Firework package 101 may be a retail firework package with an internal fuse mechanism for launching multiple fireworks by lighting a single external fuse. Firework package 101 may include one or more firework modules 102 and/or 104. Firework module 103 may be, for example, a fountain, roman candle, or a mortar.

System 100 may also include wireless reader 111 in communication with servers 112 and 113 over network 114. Wireless reader 111 includes a wireless radio transceiver and software for implementing a wireless read protocol. This wireless read protocol may include establishing an electromagnetic field to power the radio tag device. The wireless read protocol may include observing a signal from the radio tag device on the wireless radio transceiver and decoding that signal to obtain a data record. In some examples, wireless reader 111 may be a phone or tablet device such as an IPHONE, IPAD, or ANDROID-based device. In some examples, wireless reader 111 may be a hand-held reader connected to a personal computer or a point-of-sale terminal. In some examples, wireless reader 111 may implement an NFC write protocol to update information stored in an NFC device. Wireless reader 111 may include a web browser to display information such as product information or multimedia content. Servers 112 and 112 may include a database or other content.

Wireless reader 111 may read identifying information from radio tag 103. Wireless reader 111 may then query server 112 with the identifying information at block 121. At block 122, server 112 may respond with redirect information identifying server 113 as having relevant information. At block 123, wireless reader 111 may request content from server 113 and provide the identifying information. At block 124, server 113 may provide a universal resource identifier (URI) to allow wireless reader 111 to present information to an end user. A URI may be, for example, a universal resource locator (URL) such as a web address.

In some examples, server 112 may be operated by a firework distributor and server 113 may be operated by a firework retailer. When the firework retailer orders or receives inventory from the firework distributor, the firework distributor may associate fireworks package 101 and firework module 104 with the firework retailer in server 112.

In some examples, radio tags 103 and 105 may be procured from a radio tag supplier preprogrammed with information. For example, radio tag 103 may be preprogrammed with information about fireworks package 101 and radio tag 105 may be preprogrammed with information about firework module 104. In some examples, radio tags 103 and 105 may be preprogrammed with a unique identifier and the fireworks manufacturer associates each unique identifier with information about the firework module and/or package at the time of manufacture. In still other examples, radio tags 103 and 105 may be preprogrammed with a unique identifier and a stock keeping unit (SKU) identifier and applied to corresponding firework modules and/or fireworks packages at the time of manufacture.

In some examples, radio tag 103 may be strategically placed on the packaging to aid in scanning the tag with wireless reader 111. For example, radio tag 103 may be placed on a cardboard box that will be subsequently wrapped with a cover including product information and instructions. Radio tag 103 may be aligned with a printed message indicating the availability of radio tag information relating to fireworks package 101. Radio tag 103 may be adhered with adhesive strong enough to bond the tag securely to the fireworks packaging but does not interfere with the tag's functionality. The adhesive may be selected to resist environmental factors such as temperature changes and humidity. The manufacturer may select finished fireworks packages for quality control inspection to confirm alignment and adhesion are within specifications.

FIG. 1b is an illustration of system 150 for marketing fireworks, according to certain examples. System 150 includes fireworks package 101 and servers 112 and 113. In some examples, a retail location may include controller 163. Controller 163 may be a phone or tablet device such as an IPHONE, IPAD, or ANDROID-based device. In some examples controller 163 may be a computer with an RFID compatible wireless interface. Controller 163 may be in communication with server 112.

In some examples, a retailer may purchase fireworks package 101 (possibly one of many such packages purchased in bulk). The fireworks distributor may update records on server 112 to assign fireworks package 101 to the retailer. For example, if radio tags 103 includes a unique identifier, server 112 may associate that unique identifier with the retailer. After that association is made, controller 163 may be brought into radio range of fireworks package 101. Controller 163 may read the unique identifier, communicate the unique identifier to server 112 at event 161, and retrieve a tag update record at event 162. Controller 163 may apply the tag update (specified in the tag update record) to radio tag 103. This tag update record may include a URI that references the retailer's website. In this example, when wireless reader 111 scans radio tag 103 and reads the URI referencing the retailer's website. At event 171, wireless reader 111 sends the URI to server 113 and, at event 172, server 113 responds with content specified by the URI.

In some examples, radio tag 103 may be preprogrammed to include a URI that references the distributor's website and may include a unique identifier. In some examples, controller 163 may overwrite the preprogrammed URI with the URI from the tag update record. In some examples, controller 163 may engage a write-protect mode of radio tag 103 to prevent further changes to the data in that radio tag.

The URL may direct users to a centralized information page providing safety instructions, product details, or promotional contents. The content linked can range from product videos, app downloads, to interactive 3D models of the product setup.

A management platform, e.g., on server 112, may be provided to allow the distributor and retailers to manage radio tag data. This management platform may allow users to update the URI associated with a radio tag 103 or 105. The management platform may provide different tiers of access and customization. For example, some businesses may be able to provide their own URI records for radio tags 103 and 105. Other business may be able to select from a predetermined set of available URI records. For example, a business may be able to select from a product information page or a demonstrative video. In another example, some businesses may be allowed to program a URI on radio tag 103 to allow an end customer to add the item to an express checkout shopping cart to allow self-checkout or expedited checkout at the point of sale.

Controller 163 may be a base station installed at a retail or distribution location. Controller 163 may support an extended distance wireless protocol with an active RFID implementation of radio tag 103 or radio tag 105. Controller 163 may be installed locally and connected to the local network. Controller 163 may be preconfigured to connect to server 112. Controller 163 may scan radio tags 103 and 105 and request information from server 112 as it scans each tag. In some examples, controller 163 may replicate a portion of a database of records from server 112 to allow offline or more efficient handling of events 161 and 162. In some examples, controller 163 may be used to identify fireworks in current inventory at a physical location. In some examples, multiple controllers 163 may be installed locally to provide wider radio communications coverage.

This architecture introduces field level reprogramming through a secure base station controller (163). This controller, which may be, for example, a mobile device, tablet, embedded unit, or purpose-built NFC terminal, may allow authorized personnel—such as employees at a distributor or retailer—to modify the URI encoded on the tag. The controller may connect to the TMS over an encrypted HTTPS connection and authenticate using OAuth 2.0 or other token-based protocols. Upon scanning a tag, the controller may retrieves its UID and a digitally signed payload containing the new URI and, in some examples, instructions such as enable write protection. The updated URI may then be written to the tag using NDEF-compliant operations, and if required, the controller may lock the tag against future rewrites using a LOCK_BYTES or equivalent command.

In some examples, the system may accommodate both mobile and static base station configurations. While mobile devices offer the flexibility to scan and update products at the point of sale or distribution, static base stations can be deployed in fixed locations, such as regional warehouses or high-volume retail hubs. As tag technology advances and base station range improves, static infrastructure may even be capable of scanning and updating multiple nearby products without direct contact—making the system increasingly scalable and adaptable to larger operations. In some examples, an automated mobile system (e.g., a robotic device) may be used to bring a base station in radio range of each fireworks device.

In some examples, secure base station controller 163 may be offline-capable. The base station maintains a locally cached subset of the TMS database, enabling tag updates in environments with limited or no connectivity—such as rural sales locations, mobile fireworks tents, or pop-up seasonal stands. When internet access is available, secure base station controller 163 may synchronize any changes with the TMS, ensuring continuity, traceability, and integrity across the update chain.

For the consumer, the experience is immediate and intuitive. When a smartphone operating as wireless reader 111 is brought near or tapped against a tag-embedded product, the smartphone reads the NDEF-encoded URI and launches it in a mobile browser or compatible application. The link may point to a variety of dynamically managed resources—such as region-specific product pages, promotional landing sites, compliance documentation, or interactive media. Because the tag is not hardcoded, but instead points to a cloud-controlled endpoint, manufacturers and their retail partners may change the consumer experience up to the moment of sale.

Some examples of the present disclosure solve a category of technical problems that traditional NFC deployments—and certainly the fireworks industry—have not solved. Unlike standard NFC tags, which are typically written once at production and never modified, some examples of the present system allows for:
Real-time URI updates post-manufacture
Role-based access to determine who can update which tags
Field-level write capability secured by cryptographic validation
Localized and campaign-specific consumer experiences
Complete auditability of tag updates across the supply chain
Distributed reprogramming infrastructure (mobile or static)
Offline write capability with deferred synchronization
Write-lock options to permanently secure a tag post-update
Metadata-driven resolution logic from the cloud

Some examples support both NFC Forum Type 2 tags (e.g., NTAG213/215/216) for low-cost, broad deployment and Type 4 tags (e.g., NTAG424 DNA, DESFire EV2) for use cases requiring encryption, secure memory structures, or mutual authentication. Tags with richer feature sets may allow for different implementation tiers—standard tags for general use and secure tags for high-risk, more tightly regulated, or high-value products.

Some examples deliver a digitally orchestrated NFC solution that brings dynamic, programmable capabilities to a market that has had no access to digital packaging infrastructure whatsoever. Thus, physical packaging can serve as a customizable digital gateway, reconfigurable in the field, governed by access roles, and managed through secure cloud infrastructure. This architecture is not only a technical first for fireworks, but a novel blueprint for scalable, post-manufacture smart packaging across any product category where flexibility, traceability, and regional differentiation are essential.

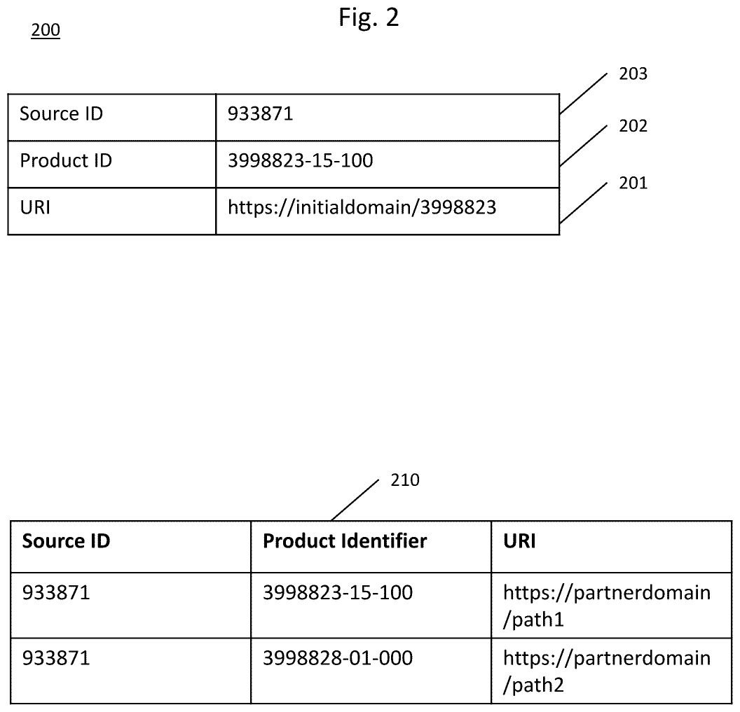

FIG. 2 is an illustration of data structures 200 for tracking firework information, according to certain examples. In some examples, a tag may contain URI 201, for example “http://domain/path/identifier1”. The portion “identifier1” may be a unique identifier assigned to the radio tag and associated with a fireworks package. In another example, the URI may be “https://initialdomain/3998823” where “initialdomain” is a domain set as of the time of manufacture and “388823” represents a product category containing this product. Wireless reader 111 may navigate to URI 201 and display the resulting web content. In some examples, a tag may contain product identifier 202. Wireless reader 111 may read the value of product identifier 202 and, via locally installed software, request content based on that value. For example, product identifier 202 may be a stock keeping unit (SKU) identifier that a point-of-sale software system might use in a database query to retrieve pricing and other information about the fireworks package. In some examples, product identifier 202 may be a globally unique identifier. In some examples, a tag may contain source identifier 203 that may identify the manufacturer or initial distributor. The collection of URI 201, product identifier 202, and source identifier 203 may be referred to as a product data record. A tag data record may contain the product data record and additional information about the tag such as a unique identifier, model information, and whether the tag has writeable data fields.

In some examples, a server with a domain of “domain” may include lookup table 210. Lookup table 210 may map each identifier to a corresponding URI. A query of the server including identifier1 results in a return of URL “https://partnerdomain/path1”. A query of the server including identifier2 results in a return of URL “https://partnerdomain/path2”. In some examples, the returned URL may be a redirect URL. In other examples, the returned URL may be stored by controller 163 into a memory on radio tag 103 or 105.

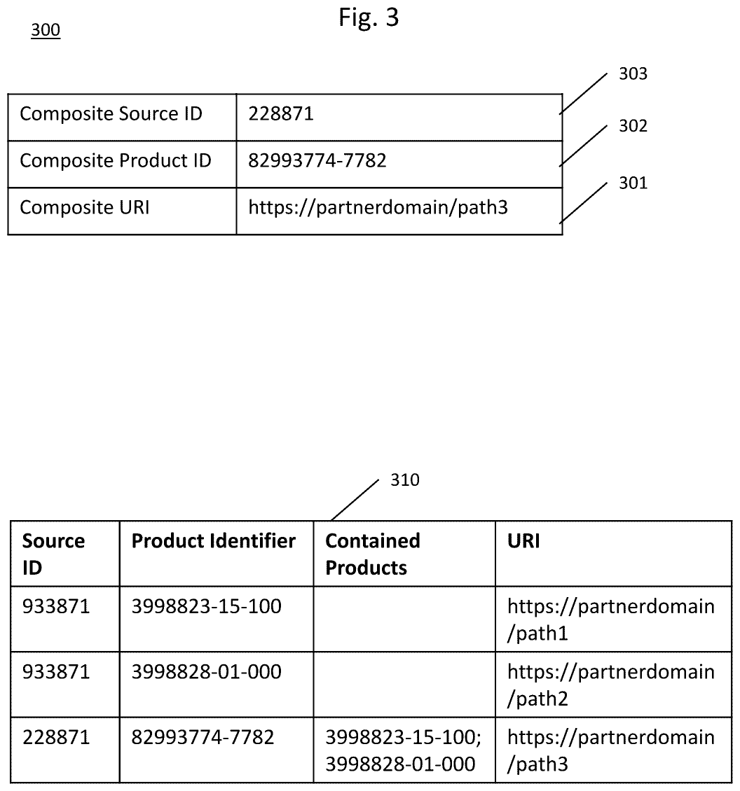

FIG. 3 is an illustration of a data structures for tracking firework information, according to certain examples. In some examples, data received from composite tag 103 from may contain URI 301, for example “https://partnerdomain/path3”, composite source identifier 303, e.g., “228871”, and composite product identifier 302, e.g., “82993774-7782”. In some examples, composite product identifier 302 may be a globally unique identifier. Composite source identifier 303 may identify the entity that combined individual firework products into the composite firework.

In some examples, a server may contain data in table 310 capturing data from multiple fireworks. Each row in table 310 may identify the source of a firework product, an identifier of that product, a list of contained products if the current product is a composite firework product, and a URI associate with that product.

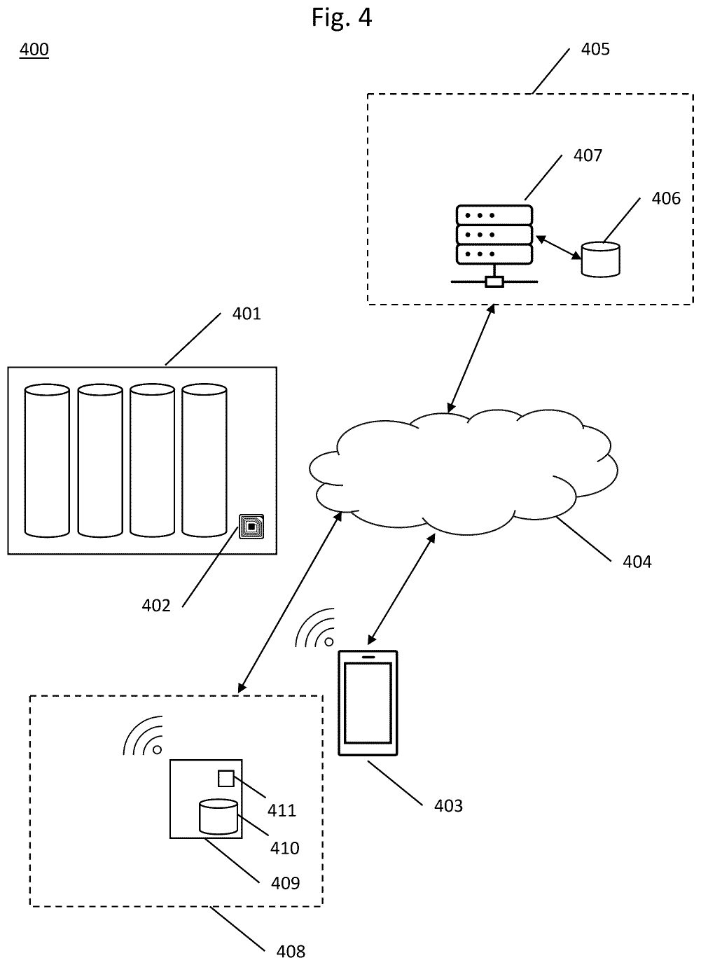

FIG. 4 is an illustration of a system for tracking firework information, according to certain examples. The system diagram in FIG. 4 may include a firework product 401 with an attached NFC tag 402. A handheld device 403, which may be a smartphone or dedicated NFC reader, may interact with the NFC tag 402 to retrieve product information. The system may also comprise a cloud network 404 that facilitates communication between various components.

Remote servers 405 may be connected to the cloud network 404 and may be responsible for managing data and content delivery. These servers may be associated with a product database 406, which may store information about firework products, and a content management system 407, which may handle the creation, updating, and delivery of product-related content.

One remote server 405 may be a centralized Tag Management Server (TMS). At the core of the system is the Tag Management Server (TMS), a cloud-based backend platform that may serve as the authoritative source of truth for all NFC tag data. The TMS may be built on a scalable, secure server infrastructure capable of processing thousands of tag interactions per second. It may expose a RESTful API layer that allows secure communication with field devices (controllers), web-based administrative tools, and content rendering endpoints.

### 1.1 Tag Registration and Metadata Mapping

Each NFC tag 402 may be assigned a globally unique identifier (UID) assigned at manufacture time and at the chip level. During packaging, this UID may be registered into the TMS along with rich metadata, for example: SKU, product name, batch number, distributor assignment, geographical routing rules, campaign identifiers, material safety information, and any legal disclaimers. These mappings may be stored in product database 406 in a normalized database schema (e.g., PostgreSQL or MongoDB), with primary key indexing on UID and time-stamped audit fields.

### 1.2 URI Resolution Engine

When a controller (409) or a smartphone (403) reads a tag, the UID or existing URI may be used as a lookup key in the TMS. A resolution engine may determine the appropriate destination URI based on contextual logic, for example: geolocation, timestamp, user role, tag history, and override flags. The response may be formatted as a digitally signed JSON payload.

### 1.3 Role-Based Access and Permissions

The TMS may enforce access controls. Entities (e.g., manufacturer, distributor, retailer) may be assigned roles with tiered write/edit capabilities. Each role governs what data can be updated, which tags are accessible, and what functions (e.g., locking tags, setting expiration windows) are permitted. Access tokens are issued using OAuth 2.0 and are stored with expiry and refresh logic.

A retailer/distributor system 408 may also be connected to the cloud network 404. This system may allow retailers or distributors to access and update product information. Within the retailer/distributor system, there may be a base station controller 409, which may be used for managing NFC tag updates and interactions in a retail or distribution environment. Base station controller 409 may include local product database 410.

The base station controller (409) may include software instructions stored in non-transitory computer readable memory 411 that may be used in distribution centers, retail stores, or mobile environments to modify NFC tag data in a secure and controlled manner. This software may be implemented, for example, as an Android/iOS app, a lightweight Linux service for embedded systems, or a browser-based NFC writer interface.

### 2.1 Initialization and Authentication

Upon launch, the controller may authenticate with the TMS using OAuth 2.0 client credentials or device-specific API tokens. This session and at least a portion of product database 406 may be cached locally to enable offline access. Controllers may be uniquely registered in the system with traceable device IDs and assigned to specific distributors or retail nodes.

### 2.2 Tag Scanning and Query

When an NFC tag is scanned, controller 409 may read the UID or placeholder URI using an NFC Forum-compliant transceiver (Type 2 or Type 4). The controller may package a secure API request including, for example, the controller device ID, user identity, UID/URI, and scan timestamp, and send that package to the TMS.

### 2.3 Payload Retrieval and Validation

The TMS may respond with a JSON payload containing, for example, a new URI, optional write-protect flags, validity windows, and a digital signature. The controller may verify the signature using a public key stored locally or retrieved via a secure network connection (e.g., secured with TLS). Failed validations may be logged and unauthorized payloads may be rejected.

### 2.4 Write Operation and Locking

Once validated, controller 409 may write the new URI to NFC tag 402 using the NDEF protocol. If specified, controller 409 may execute a LOCK_BYTES command to render some or all of the data portion of NFC tag 402 read-only. Successful writes may trigger local logging and may generate a POST callback to the TMS to register the successful update.

### 2.5 Offline Mode

In offline scenarios, controller 409 may reference in local database 410 a locally synchronized mirror (or partial mirror) of product database 406. Writes may be executed based on cached resolution logic, and a queue of unsynced updates may be maintained until the network is restored. In some examples, a queue of unsynced successful writes may be maintained until the network is restored and those writes may be transmitted to TMS 407.

In operation, the system may allow for data transfer between the NFC tag 402 on the firework product 401 and the handheld device 403. This information may be transmitted through the cloud network 404 to the remote servers 405 for processing and storage in the product database 406. The content management system 407 may provide relevant information back through the network. The retailer/distributor system 408 may access and update information via the cloud network 404, while the base station controller 409 may interact with the NFC tag 402 for inventory management or product tracking purposes.

### 3.1 Digital Signing of Payloads

URI payloads issued by the TMS may be digitally signed using RSA-2048 or ECC-P256. The controller may perform public key validation before applying any update to data in NFC tag 402. This security check may prevent man-in-the-middle attacks or spoofed write instructions.

### 3.2 Encrypted Communications

Controller-to-TMS communications may occur over HTTPS (TLS 1.2+). In some examples, tokens are encrypted while at rest and may be refreshed via time-bound rotation policies.

### 3.3 Audit Logging

In some examples, every interaction with NFC tag 402 may be logged with, for example, UID, timestamp, geolocation (if available), controller ID, user ID, and operation type (read/write/lock). Logs may be stored in the TMS for at least 24 months and may be exportable for compliance review.

### 4.1 NFC Tag Tap and URI Resolution

When a consumer taps NFC-enabled smartphone 403 to NFC tag 402, smartphone 402 may read the URI via its native NFC reader. The browser may be directed via the URI to a content endpoint hosted by content management system 407.

### 4.2 Content Personalization and Rendering

In some examples, the landing page may dynamically personalize content based on, for example, location, device type, language, or active promotions. In some examples, dynamic personalization may be triggered by or based on the UID or embedded tracking tokens. Session data may also be captured for analytics in some examples.

### 4.3 Mobile Compatibility

In some examples, content management system 407 may deliver responsive content designed for mobile rendering. In cases where advanced interaction is needed (e.g., augmented reality), the URI may deep-link into a mobile app.

### 5.1 Modular API Design

In some examples, the TMS uses modular microservices (e.g., URI resolver, access manager, analytics engine) that may be independently scaled and deployed.

### 5.2 Tag Type Flexibility

In some examples, the system may be compatible with any NFC Forum-compliant tag. Type 2 tags may be used for general applications, while Type 4 tags may be used for high-security use cases.

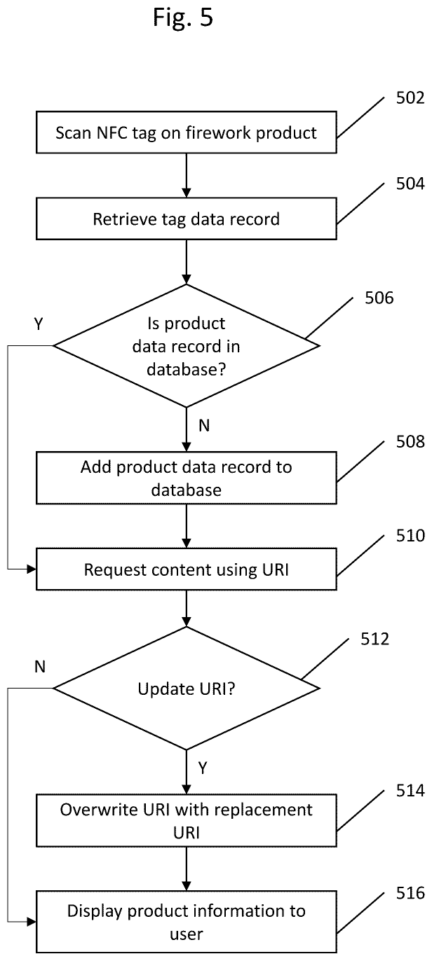

FIG. 5 illustrates a method for processing firework information, according to certain examples. The method may begin with block 500, where an NFC tag on a firework product is scanned. In block 501, the tag data record may be retrieved from the NFC tag. The method may then move to decision point 502, where the system checks if the product data record is already in the database.

If the record is not in the database (the “no” branch from 502), the method may proceed to block 503, where the product data record is added to the database. If the record is already in the database (the “yes” branch from 502), or after adding the record in block 503, the method may move to block 504.

In block 504, the system may request content using the URI stored in the tag data record. The method may then move to decision point 505, which checks if the URI needs to be updated. If an update is required (yes branch from 505), the method may proceed to block 506, where the URI may be overwritten with a replacement URI. If no update is needed (no branch from 505), the method may skip block 506.

Both branches may then converge at block 507, where the product information may be displayed to the user. This flowchart may illustrate a structured approach to processing NFC tag data from firework products, including database checks, content retrieval, and potential URI updates.

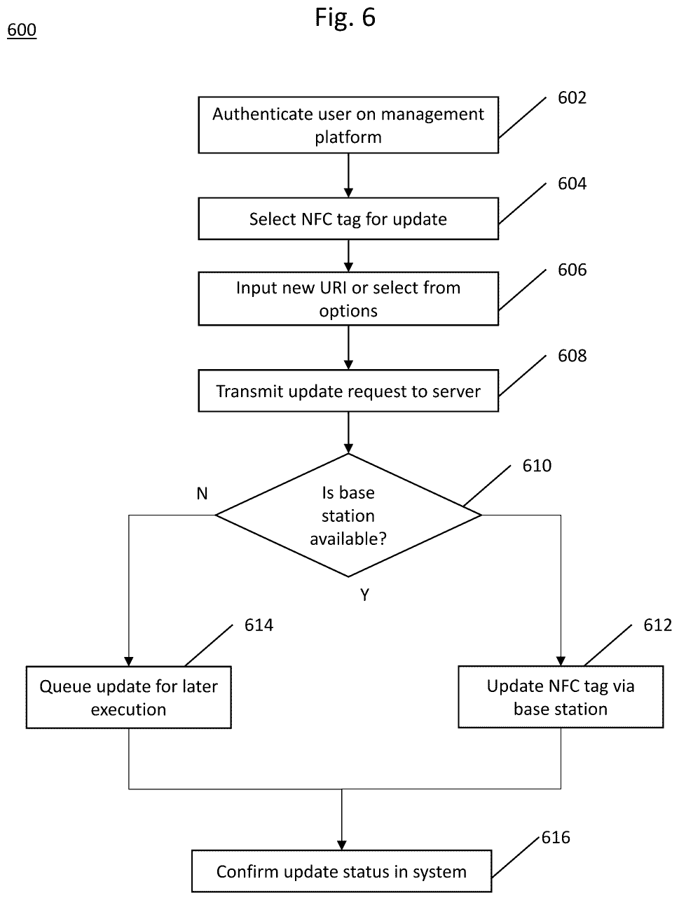

FIG. 6 is a method for managing firework information, according to certain examples. The method may begin at block 600, where a user may be authenticated on a management platform. Following authentication, the method may move to block 601, where the user may select an NFC tag for update. In block 602, the user may input a new URI or select from available options.

The method may then proceed to block 603, where an update request may be transmitted to a server. At decision point 604, the system may check if a base station is available for performing the update. If a base station is available (yes branch from 604), the method may move to block 605, where the NFC tag may be updated via the base station.

If a base station is not available (no branch from 604), the method may go to block 606, where the update may be queued for later execution. Both paths may then converge at block 607, where the update status may be confirmed in the system.

This flowchart may depict a sequential method for updating NFC tag content, incorporating user authentication, tag selection, content input, and update transmission. The method may include a decision point to determine the availability of a base station, allowing for immediate updates when possible or queuing updates for later execution when necessary.

Although example embodiments have been described above, other variations and embodiments may be made from this disclosure without departing from the spirit and scope of these embodiments. For example, table descriptions are exemplary and in practice this data may be normalized or represented in other formats.

What is claimed is:

1. A computer-implemented method comprising:
scanning a radio tag incorporated into packaging of a firework product to retrieve a tag data record, the tag data record comprising:
a source identifier,
a firework product identifier, and
a universal resource identifier (URI); and
at least one of:
adding a product data record to a product database, the product data record comprising at least the firework product identifier, and
requesting from the URI content related to the firework product by.

2. The computer-implemented method of claim 1, comprising:
signaling the radio tag to overwrite the URI of the tag data record with a replacement URI; and
signaling the radio tag to prevent future changes to the tag data record.

3. The computer-implemented method of claim 2, wherein:
the URI points to first information about the firework product hosted by a first website; and
the replacement URI points to second information about the firework product hosted by a second website.

4. The computer-implemented method of claim 3, wherein:
the second website is sponsored by a fireworks seller.

5. The computer-implemented method of claim 2, comprising:
creating a record in an online database specific to the firework product, the firework product specific record comprising:
a scan timestamp,
a user identifier,
at least one of a reference to a firework distributor and a reference to a firework retailer, and
a redirect-URI to provide in response to a request to the replacement URI.

6. The computer-implemented method of claim 1, comprising:
scanning a second radio tag incorporated into the packaging of a composite firework product comprising the firework product to retrieve a composite tag data record, the composite tag data record comprising:
a second source identifier associated with the source of the composite firework product,
a composite firework product identifier, and
a second URI; and
adding the composite tag data record to the product database, the composite tag data record comprising at least the composite firework product identifier.

7. The computer-implemented method of claim 6, comprising:
determining the second radio tag is associated with the composite firework product.

8. A non-transitory computer readable medium comprising instructions that when executed on a methodor:
scan a radio tag incorporated into packaging of a firework product to retrieve a tag data record, the tag data record comprising:
a source identifier,
a firework product identifier, and
a universal resource identifier (URI); and
at least one of:
add a product data record to a product database, the product data record comprising at least the firework product identifier, and
request from the URI content related to the firework product by.

9. The non-transitory computer readable medium of claim 8, comprising instructions that when executed on the methodor:
signal the radio tag to overwrite the URI of the tag data record with a replacement URI; and
signal the radio tag to prevent future changes to the tag data record.

10. The non-transitory computer readable medium of claim 9, wherein:
the URI points to first information about the firework product hosted by a first website; and
the replacement URI points to second information about the firework product hosted by a second website.

11. The non-transitory computer readable medium of claim 10, wherein:
the second website is sponsored by a fireworks seller.

12. The non-transitory computer readable medium of claim 9, comprising instructions that when executed on the methodor:
create a record in an online database specific to the firework product, the firework product specific record comprising:
a scan timestamp,
a user identifier,
at least one of a reference to a firework distributor and a reference to a firework retailer, and
a redirect-URI to provide in response to a request to the replacement URI.

13. The non-transitory computer readable medium of claim 8, comprising instructions that when executed on the methodor:
scan a second radio tag incorporated into the packaging of a composite firework product comprising the firework product to retrieve a composite tag data record, the composite tag data record comprising:
a second source identifier associated with the source of the composite firework product,
a composite firework product identifier, and
a second URI; and
add the composite tag data record to the product database, the composite tag data record comprising at least the composite firework product identifier. 14 The non-transitory computer readable medium of claim 13, comprising instructions that when executed on the methodor:
determine the second radio tag is associated with the composite firework product.

15. A device comprising:
a fuse,
a combustible material,
a package substantially containing the combustible material, and
a radio tag affixed to the package,
wherein the radio tag stores a tag data record comprising:
a source identifier,
a product identifier, and
a universal resource identifier (URI).

16. The device of claim 15, wherein the URI was first fixed prior to delivery of the device by the device manufacturer.

17. The device of claim 15, wherein the URI was modified after delivery of the device by the device manufacturer.

18. The device of claim 17, wherein the modified URI points to information about the device hosted by a retail seller.

19. The device of claim 15, comprising:
a second layer of packaging comprising the package and a composite radio tag affixed to the second layer of packaging,
the composite radio tag comprising a composite tag data record, the composite tag data record comprising:
a second source identifier associated with the source of the composite product,
a composite product identifier, and
a second URI.

20. The device of claim 19, wherein the composite tag data record indicates that the composite radio tag is a composite radio tag.
